(19) United States
(12) Patent Application Publication
(10) Pub. No.: US 2004/0264163 A1
(43) Pub. Date: Dec. 30, 2004

(54) Light guide

(76) Inventor: Te-Hsiang Fang, Taipei Hsien (TW)

Correspondence Address: BRUCE H. TROXELL, SUITE 1404, 5205 LEESBURG PIKE, FALLS CHURCH, VA, 22041, US

(21) Appl. No.: 10/642,832

(22) Filed: Aug. 19, 2003

(30) Foreign Application Priority Data
Jun. 26, 2003 (CN) 03247699.X

(51) Int. Cl. F21V 7/04

(52) U.S. Cl. 362/31

(57) ABSTRACT

A light guide is constructed to include two light guide elements abutted against each other, a plurality of grooves engraved on one light guide element and forming a plurality of light passages in between the two light guide elements, and a message put upon the one light guide element inside the light passages.

### BACKGROUND OF THE INVENTION

1. Field of the Invention

The present invention relates to a light guide and, more particularly, such a light guide practical for use in a small personal item having light means.

2. Description of the Related Art

Small personal items with light means such as light pens, mini flashlights, light key-rings, etc. are commercially available. These items commonly have a lighting circuit formed of a battery, a bulb, and a press-button switch. When switched on the press-button switch, the bulb is turned on to emit light. Different colors of bulbs may be used to emit different colors of light. These items can be used as a company's gifts to its employees or clients. The inventor invented a similar design, which is a light pen that comprises a lighting device mounted in the penholder, and a cylindrical light guide fastened to the pen cap and aimed at the lighting device. The light guide is molded from transparent plastics, having longitudinally extended light guide holes. When turning on the bulb, light passes from the bulb through the light guide holes of the light guide, producing a light column that attracts people eyes. This design of light guide is still not satisfactory in function. Because the light guide is a solid plastic member, it is difficult to put a design inside the light guide. When putting a design inside the light guide, the molding cost is high.

### SUMMARY OF THE INVENTION

The present invention has been accomplished under the circumstances in view. It is therefore the main object of the present invention to provide a light guide, which eliminates the aforesaid drawbacks.

According to one aspect of the present invention, the light guide comprises at least two light guide elements abutted against one another, and a plurality of grooves engraved on at least one light guide element and forming a plurality of light passages in between at least two of the at lest two light guide elements.

According to another aspect of the present invention, a message is put upon the grooves at one light guide element before assembling the light guide elements. The message can be a logo, sign, graphic device, blurb, etc. subject to clients' requirements.

### BRIEF DESCRIPTION OF THE DRAWINGS

FIG. 1 illustrates a light pen mounted with a light guide according to the present invention.

FIG. 2 is a schematic drawing showing the light guide connected to the lighting device according to the present invention.

FIG. 3 is a cross sectional view in an enlarged scale of the cap of the light pen shown in FIG. 1.

FIG. 4 is an elevational view of a light guide according to the present invention.

FIG. 5 is a top plain view of the grooved light guide element for the light guide according to the present invention.

FIG. 6 is an enlarged side view of the grooved light guide element for the light guide according to the present invention.

FIG. 7 is a top plain view of the grooved light guide element for the light guide according to the present invention after branding of the message.

FIG. 8 is a cross sectional view of the light guide according to the present invention.

### DETAILED DESCRIPTION OF THE PREFERRED EMBODIMENT

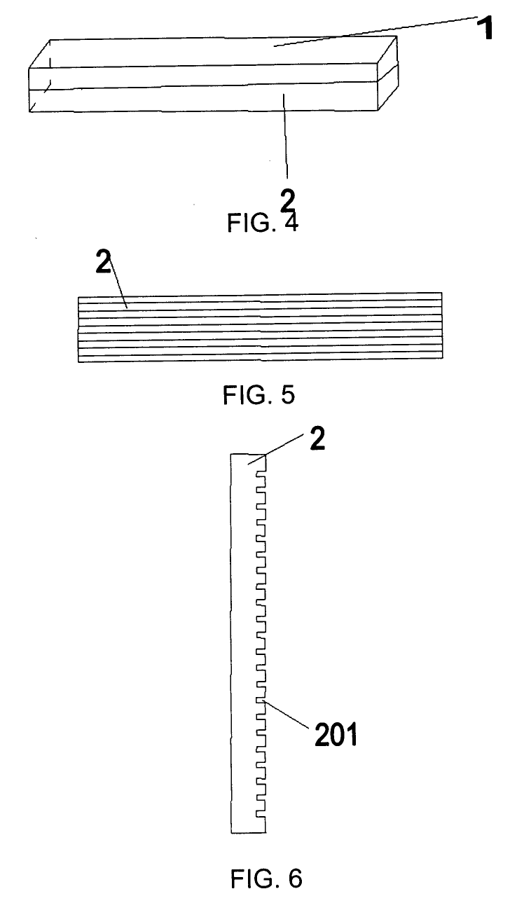

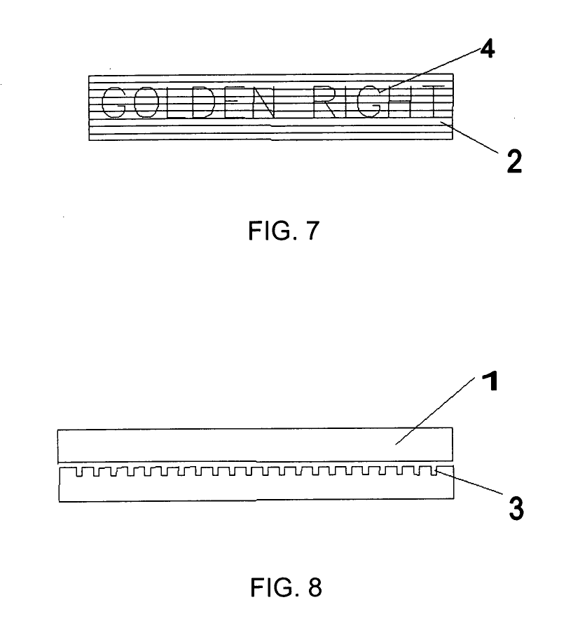

Referring to FIG. 4, a light guide is comprised of two light guide elements 1 and 2 arranged in a stack. One light guide element 1 is made of transparent material, having a smooth outer surface. The other light guide element 2 has one side (namely, the outer side) smooth and the other side (namely, the inner side) engraved with elongated grooves 201 (see FIGS. 5 and 6). A message 4, for example, “GOLDEN RIGHT” is put upon the inner side of the light guide element 2 by a hot iron (see FIG. 7). Thereafter, the light guide elements 1 and 2 are arranged in a stack and firmly fastened together, keeping the grooves 201 of the light guide element 2 facing the light guide element 1. Therefore, light passages 3 are formed in the light guide between the light guide elements 1 and 2 (see FIG. 8).

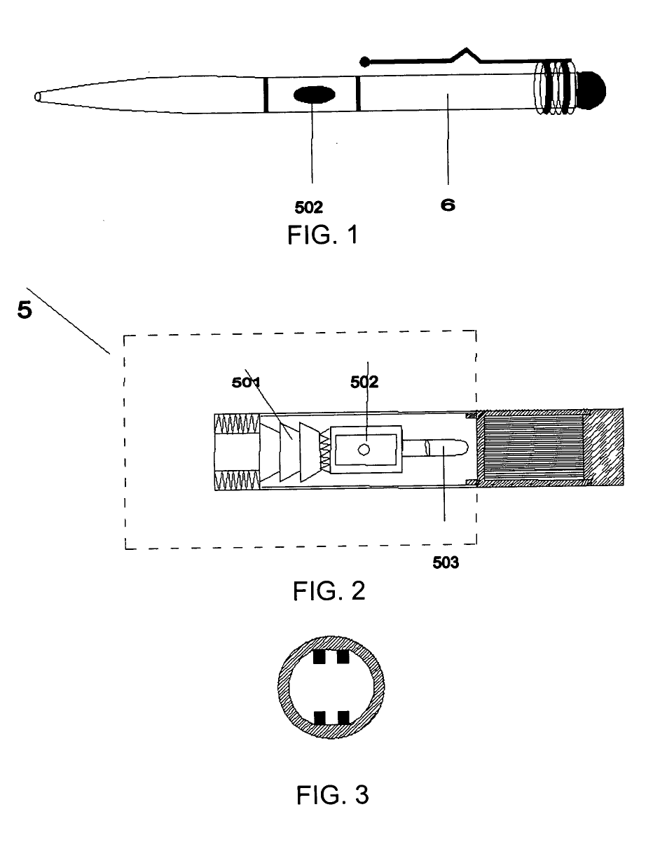

FIGS. 1-3 show the light guide used in a light pen. The light guide is mounted in the inside chamber of the pen cap 6 of the light pen (see FIG. 3). At the left side of the light guide is provided a lighting device 5, which is comprised of a battery 501, a press-button switch 502, and a bulb 503. When switched on the press-button switch 502, the bulb 503 is turned on to emit light toward the light passages 3 of the light guide, and therefore the message “GOLDEN RIGHT” is illuminated. The light pen can be used as a gift of a company to its employee or client.

In the aforesaid embodiment, only one light guide element engraved with elongated grooves. The elongated grooves can be formed in either of the two light guide elements. Alternatively, elongated grooves can be formed in both two light guide element in a symmetrical or staggered manner. The elongated grooves can be made having a rectangular, circular, or triangular cross section. The light guide elements can be rectangular plates, half-round bars, triangular bars. Alternatively, the light guide can be formed of three or more light guide elements, and shaped like a rectangular bar, cylindrical bar, or prism.

The message 4 can be printed on the grooved side of the light guide element, or put upon the grooves 201 of the light guide element 2 by a hot iron.

In the aforesaid application example, the light guide is used in a light pen. Alternatively, the light guide can be used in a flashlight, or a light key-ring.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A light guide comprising at least two light guide elements abutted against one another, and a plurality of grooves engraved on at least one said light guide element and forming a plurality of light passages in between at least two of said at lest two light guide elements.

2. The light guide as claimed in claim 1, further comprising a message disposed inside said light passages.

3. The light guide as claimed in claim 1, wherein said light passages have a rectangular cross section, circular cross section, or triangular cross section.

4. The light guide as claimed in claim 2, wherein said light passages have a rectangular cross section, circular cross section, or triangular cross section.

5. The light guide as claimed in claim 1, wherein said light guide elements are shaped like a rectangular bar, a round bar, or a triangular bar when abutted against one another.

6. The light guide as claimed in claim 2, wherein said light guide elements are shaped like a rectangular bar, a round bar, or a triangular bar when abutted against one another.
